(19) United States
(12) Patent Application Publication
(10) Pub. No.: US 2008/0226264 A1
(43) Pub. Date: Sep. 18, 2008

(54) Recording medium handling apparatus and method

(75) Inventors: Yukinori Asada, Yokohama (JP); Takashi Kanemaru, Yokohama (JP)

Correspondence Address: MCDERMOTT WILL & EMERY LLP, 600 13TH STREET, N.W., WASHINGTON, DC, 20005-3096, US

(73) Assignee: HITACHI LTD.

(21) Appl. No.: 12/000,815

(22) Filed: Dec. 18, 2007

(30) Foreign Application Priority Data
Mar. 16, 2007 (JP) 2007-067808

(51) Int. Cl. H04N 7/26

(52) U.S. Cl. 386/124

(57) ABSTRACT

Some video recording and reproducing apparatus require predetermined initialization processing and so take a certain period of time after a power is turned on until library information is displayed. Also with removable recording media, it takes time from inserting a recording medium until library information appears on a display. To address this problem, a library function and apparatus are provided which display library information before the initialization processing is completed. Further, a library function and apparatus are provided which, when a recording medium that has been recorded by other video recording and reproducing apparatus is inserted, automatically update the library information.

### INCORPORATION BY REFERENCE

The present application claims priority from Japanese application JP 2007-067808 filed on Mar. 16, 2007, the content of which is hereby incorporated by reference into this application.

### BACKGROUND OF THE INVENTION

The present invention relates to a recording medium handling apparatus, such as a recording and reproducing apparatus, that can reproduce information recorded in a removable recording medium and record information in it by loading the recording medium into the recording medium handling apparatus.

In connection with the technical field described above, JP-A-2002-150754 describes it as an object to “provide a video recording and reproducing apparatus having a library function of easily identifying and managing recorded images by managing in a hard disk and displaying all library information on images recorded in optical discs and hard disks. To achieve this objective, JP-A-2002-150754 provides “a video recording and reproducing apparatus that records and reproduces image information to and from removable optical discs 11 and built-in hard disks 13 and which, when recording images in the optical discs 11 and hard disks 13, creates library information on the recorded images and stores it in the hard disk so that many images contained in a plurality of optical discs and hard disks can all be identified and managed by editing and displaying the library information as required.”

Although JP-A-2002-150754 makes provisions for the library information, there are some points that need improvements. JP-A-2002-150754 uses optical discs in the form of removable recording media. Some recording media may take time for initial processing (including certification procedure between the apparatus and a recording medium; the initial processing is not a so-called formatting that erases all recorded content in the medium; this processing is also called an initialize, initialization processing or starting processing). This problem needs to be addressed. Another problem is that JP-A-2002-150754 does not consider an automated update of library information when handling images that are recorded by other video recording and reproducing apparatus.

### SUMMARY OF THE INVENTION

In light of these problems, a library function and an apparatus are provided which, when a recording medium that takes time for the initial processing is used, display library information before the initial processing on the recording medium is completed. Also a library function and an apparatus are provided which, when a recording medium recorded by other video recording and reproducing apparatus is inserted, automatically update library information.

With the above means a usability of the library function and the apparatus for the user can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example configuration of a video recording and reproducing apparatus.

FIG. 2 is a flow chart showing example processing performed when a recording medium is inserted into the video recording and reproducing apparatus.

FIG. 3 is a flow chart showing example processing performed when a power of the video recording and reproducing apparatus is turned on.

FIG. 4 is a flow chart showing example processing performed when a medium is inserted into a remote controller.

FIG. 5 shows an example screen (1) displaying library information of a recording medium ID=#1.

FIG. 6 shows an example screen (2) when a recording medium is inserted.

FIG. 7 shows an example screen (3) when library information associated with the inserted recording medium is not found in the video recording and reproducing apparatus.

FIG. 8 shows an example screen (4) displaying library information when the library information associated with the inserted recording medium ID=#11 is found in the video recording and reproducing apparatus.

FIG. 9 shows an example screen (5) when the inserted recording medium ID=#11 has already been updated by other video recording and reproducing apparatus.

FIG. 10 shows an example screen (6) when the library information associated with the inserted recording medium ID=#11 is updated following the starting processing (initial processing) of the recording medium.

FIG. 11 is an external view of an example construction of a remote controller.

FIG. 12 is a flow chart showing an example of initialization processing performed in the video recording and reproducing apparatus and a recording medium.

### DETAILED DESCRIPTION OF THE INVENTION

A preferred embodiment of the present invention will be described. It is, however, noted that the present invention is not limited to this embodiment.

### Example Configuration of Video Recording and Reproducing Apparatus

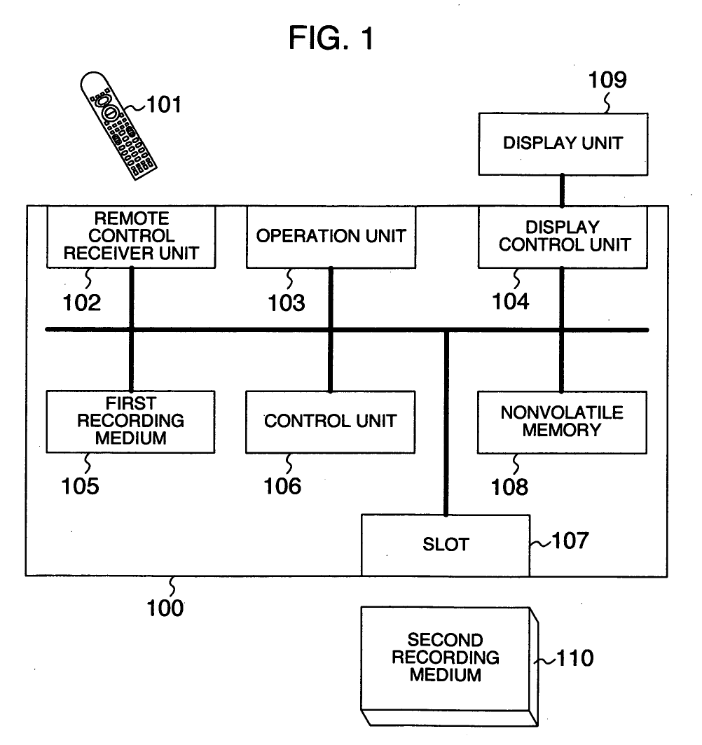

FIG. 1 shows an example configuration of circuit blocks in a video recording and reproducing apparatus (recording medium handling apparatus). In the following explanation, a television display apparatus is taken as an example of the video recording and reproducing apparatus.

Designated 100 is an overall controller of the television display apparatus which is controlled by a control unit 106 that performs an arithmetic control operation according to a program stored in a nonvolatile memory 108. The overall controller 100 can be operated by a remote controller (or simply referred to as a “remote”) 101. A remote control signal from the remote 101 is received by a remote control receiver unit 102 which transfers it to the control unit 106. The control unit 106 analyzes a command contained in the received remote control signal or in information entered from an operation unit 103 and controls operation of each unit, displaying information on a display unit 109 through a display control unit 104. Denoted 105 is a first recording medium to record video content and library information described later. Denoted 110 is a second recording medium to record video content and library information, as with the first recording medium 105. In this embodiment it is assumed that the first recording medium 105 is of a built-in type and the second recording medium 110 a removable type, and that the removable second recording medium 110 is inserted into a slot 107 for data retrieval. The first recording medium 105 and the second recording medium 110, however, are not limited to the built-in or removable type and two or more of them may be used. Further, a plurality of the slots 107 may be provided. Examples of the first recording medium 105 include a HDD (hard disk drive) and an SDRAM, and examples of the second recording medium 110 include a removable HDD called iVDR (information Versatile Disc for Removable usage).

### <Explanation of Library Information>

The first recording medium 105 can record library information on recorded video content. The library information includes not only information on video content recorded in the first recording medium 105 but also information on video content recorded in the removable second recording medium 110 using the video recording and reproducing apparatus. For example, when a certain program is recorded by loading a second recording medium 110 with an ID of #1 into the slot 107, the ID of the second recording medium 110 and information on the recorded program (channel, program title, recording date and time, etc.) are stored as the library information in the first recording medium 105 (this storing of information may also be called a “library registration”). Thus the library information is kept in the first recording medium 105 if the second recording medium 110 (#1) is taken out of the slot 107. With this embodiment, therefore, the library information on the recorded program in the second recording medium 110 can be configured and displayed by the video recording and reproducing apparatus as long as the second recording medium 110 has its video content recorded by the video recording and reproducing apparatus.

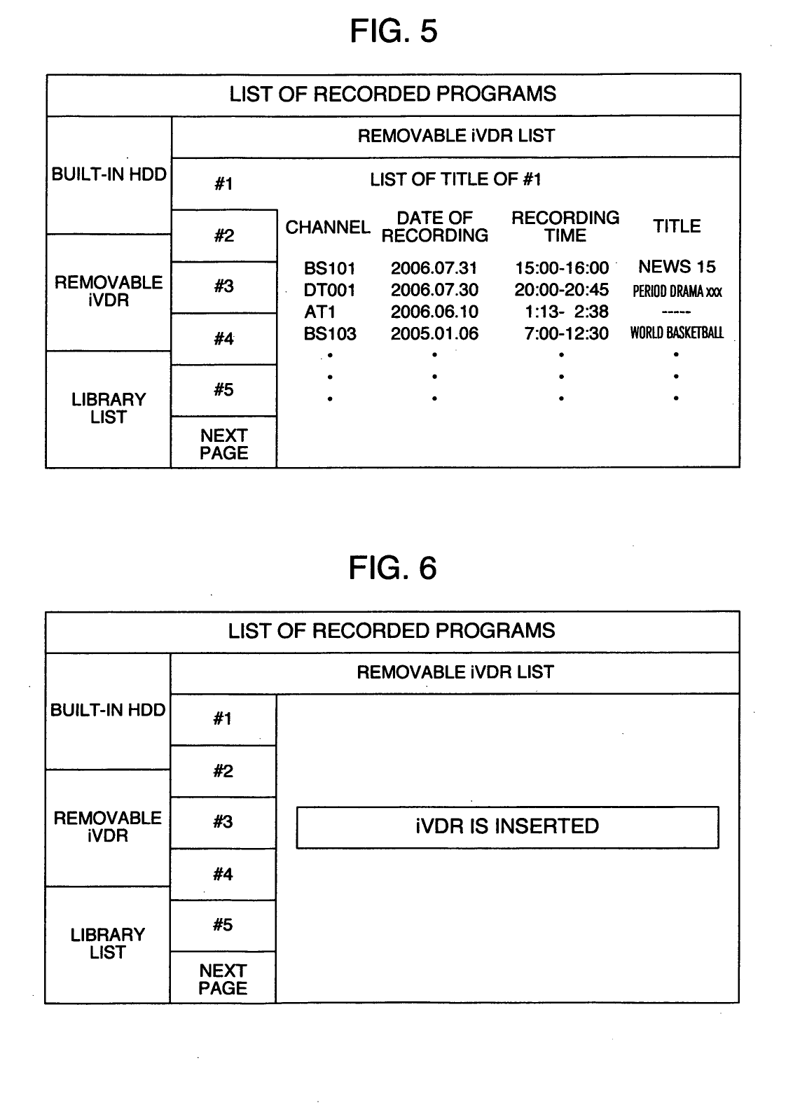

FIG. 5 shows an example screen displaying library information (referred to as a library screen). In the example of FIG. 5, an HDD is used as the first recording medium and an iVDR as the second recording medium. As shown in FIG. 5, the library screen in this embodiment is given a title “List of recorded programs” and has vertically arranged on the left side a selection item for selecting a type of recording medium (built-in HDD/removable iVDR) and a selection item for selecting a library list.

If the “List of recorded programs” is chosen, a list appears on the screen showing a list of all programs recorded in the built-in HDD and those that are recorded in the removable iVDR and library-registered with the video recording and reproducing apparatus. If the “built-in HDD” or “removable iVDR” is selected, a list of programs recorded in the selected recording medium is displayed. Further, a selection of “library list results in a list of libraries being displayed. FIG. 5 represents a case where the “library list” is chosen and libraries for a “removable iVDR list” are displayed. The “removable iVDR list shows iVDRs that have in the past been inserted into the video recording and reproducing apparatus. In FIG. 5, “#1” to “#5 are IDs that the video recording and reproducing apparatus has attached to iVDRs for their identification. “#6” and subsequent IDs can be viewed and operated on by selecting “next page”. Further, selecting a title (identification information of iVDR) of a desired iVDR from the “removable iVDR list” can cause a list of programs recorded in that iVDR to appear on the right side. The list of recorded programs shows a selected channel, a date of recording, a recording time and a title for each recorded program. That is, in the example of FIG. 5, an iVDR library corresponding to “#1” is selected and its library information is displayed. If the video recording and reproducing apparatus is not a television display apparatus, the library information may be output and hardware for outputting the library information is also called a library information output unit.

### <Explanation on Library Management Information>

To correlate library information and a recording medium, the video recording and reproducing apparatus has recorded therein as library management information “unique information” that can uniquely identify the recording medium. For example, it may be a serial number assigned to each product. Further, to make it possible, when a recording medium is inserted into the video recording and reproducing apparatus, to check whether or not the content of the recording medium has been updated since it was last inserted into the video recording and reproducing apparatus, “history information” indicating what state the recording medium is currently in is recorded in the video recording and reproducing apparatus and in the recording medium. The history information may include, for example, a last recording time on a medium (the last recording here refers to a most recent recording on the medium including at least one of additional recording, deletion, overwriting and editing operations; simple playback operations do not need to be reflected on the last recording), an available capacity, a total capacity, the number of files, the number of directories and manufacturers' names. UDF (Universal Disk Format) can use LVID (Logical Volume Integrity Descriptor). These “unique information” and “history information” are recorded in those areas in the recording mediums that can be retrieved from the video recording and reproducing apparatus without going through the initial processing. Hardware to retrieve the library management information (also called management information) from the recording medium by having the control unit 106 execute a program stored in the nonvolatile memory 108 of FIG. 1 is also called a management information acquisition unit.

<Explanation on Updating of Library Information and Library Management Information when Content is Recorded in Recording Medium in Video Recording and Reproducing Apparatus>

When content is recorded in a recording medium in the video recording and reproducing apparatus, library information and library management information are retrieved from the recording medium and then updated to the latest information.

If the recording medium is the one that has in the past been inserted into the video recording and reproducing apparatus, there are library information and library management information in the video recording and reproducing apparatus. So, these information need only be updated. If the recording medium is the one that is inserted for the first time in this apparatus, new library management information is recorded or registered with the video recording and reproducing apparatus and then library information corresponding to the library management information is acquired and registered with the video recording and reproducing apparatus. So, this information needs to be updated. The new registration of library management information may be done when the recording medium is inserted or when the recording medium is first recorded with content by the video recording and reproducing apparatus.

### <Explanation on Initial Processing>

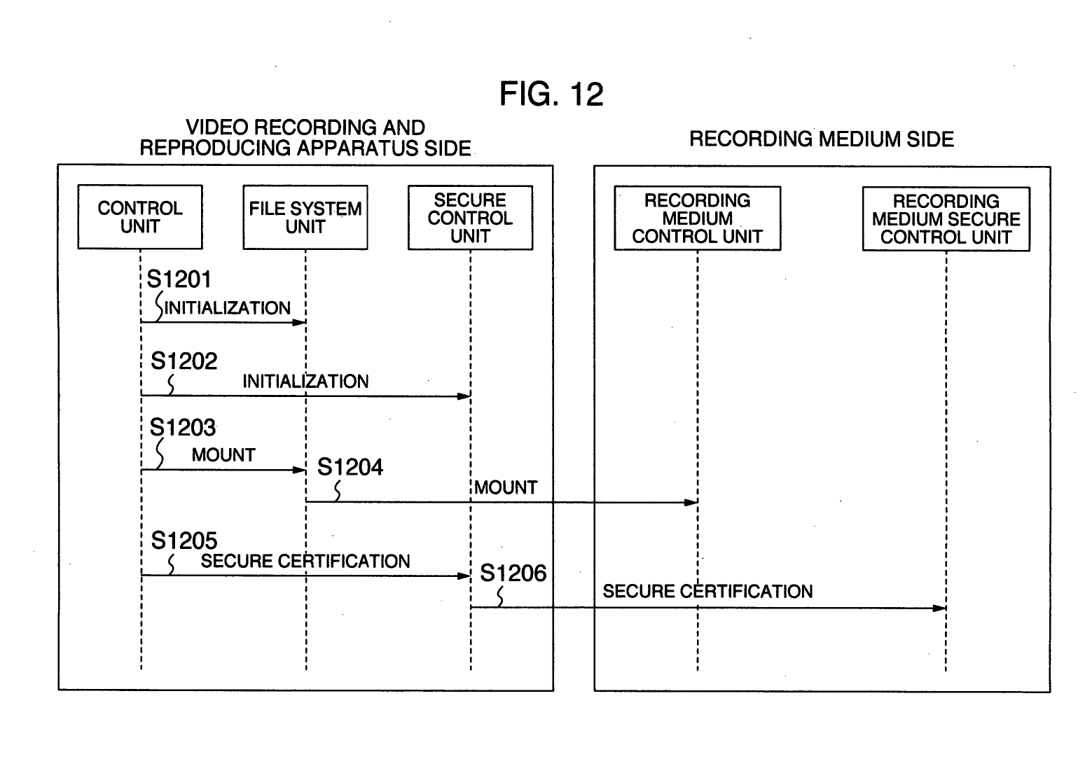

Some of the recording media require the initial processing that takes a certain length of time. Content protection processing required when handling digital content is often included in the initial processing. An example procedure for the initial processing as performed in the video recording and reproducing apparatus and a recording medium will be explained by referring to FIG. 12.

A control unit, a file system unit and a secure control unit (also called a certification unit) on the video recording and reproducing apparatus side in FIG. 12 are included in the control unit 106. More specifically, they are implemented by the control unit 106 executing a program stored in the memory 108. A recording medium control unit and a recording medium secure control unit on the recording medium side are included in the second recording medium of FIG. 1 and more specifically implemented by an LSI in a cartridge of the second recording medium. The first recording medium may also be configured in the similar manner.

In the case of a video recording and reproducing apparatus with a recording medium inserted therein or with a built-in recording medium, when a power is turned on, the video recording and reproducing apparatus first performs the initialization processing on the file system unit that manages data and management files in the recording medium and on the secure control unit that realizes content protection (S1201, S1202 in FIG. 12). Next, the file system unit performs mount processing on the recording medium (S1203, S1204 in FIG. 12). The mounting means a device connecting operation performed by software to enable OS to access files in external storage devices such as hard disk drives and optical disc drives and in network drives. After the mounting operation is completed normally, to check if the content protection function of the recording medium is normal, a secure certification operation is performed (S1205, S1206 in FIG. 12). Among secure techniques for protection of content in recording media is, for example, SAFIA (Security Architecture For Intelligent Attachment device). After the secure certification is complete, the medium can now be used as a recording medium and an access can be made to content in the medium. These initialization operations are executed on each print medium. That is, when a plurality of recording mediums are inserted in the video recording and reproducing apparatus, these operations are performed on a one-to-one basis.

Hardware to perform the initialization operation on the recording medium by having the control unit 106 execute a program stored in the nonvolatile memory 108 of FIG. 1 is also called an initialization execution unit. This may include, for example the control unit, the file system unit and the secure control unit in FIG. 12.

### Example Procedure for Displaying Library Information

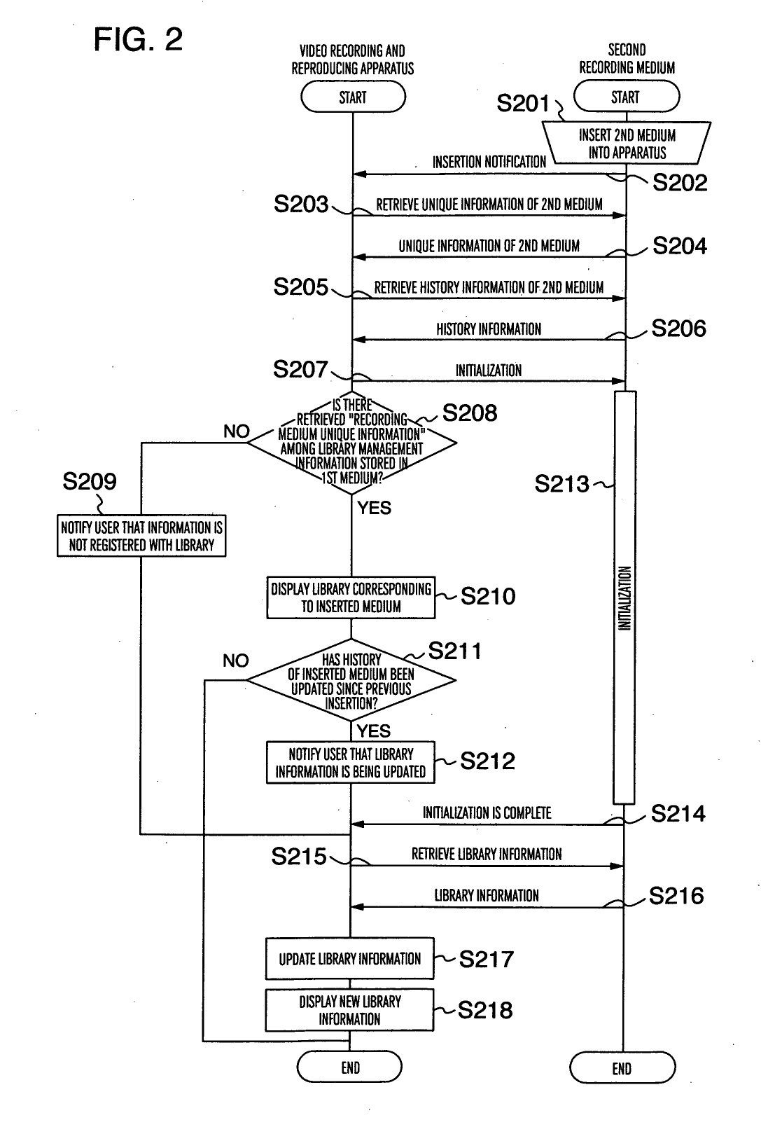

Processing for displaying library information relatively quickly even if a recording medium is used which takes time in the initialization (start processing) will be explained by referring to FIG. 2.

FIG. 2 shows an example of processing that the video recording and reproducing apparatus performs on a second recording medium 110 when the removable second recording medium 110 is inserted into the video recording and reproducing apparatus.

When a second recording medium 110 is inserted into the video recording and reproducing apparatus (S201 of FIG. 2), the video recording and reproducing apparatus receives an insertion notification indicating that the second recording medium is inserted (S202 of FIG. 2). Although, for simplicity of explanation, the insertion notification has been described here to be sent from the second recording medium 110 to the video recording and reproducing apparatus, it is possible for the video recording and reproducing apparatus to also detect by hardware when the second recording medium 110 is inserted. Further, when it detects that second recording medium 110 is inserted, the video recording and reproducing apparatus may display a message reading, for example, “iVDR is inserted” as shown in FIG. 6, notifying the user of the medium insertion. The notification may be other message or voice. These also apply to other examples of screen.

“Unique information” of the second recording medium 110 is acquired (S203, S204 of FIG. 2). “History information” of the second recording medium 110 is also retrieved (S205, S206 of FIG. 2). Here there is no limitation on the order of retrieval of “unique information” and “history information”.

The video recording and reproducing apparatus performs the initial processing on the second recording medium 110 (S207 of FIG. 2). During the initial processing (S213 of FIG. 2) on the second recording medium 110, it is generally not possible to make access to video content and library information. This is because the driver initialization and secure certification are executed during the initial processing as described earlier and the recording medium can only be used after the initial processing is complete. There are some recording media that do not require the initial processing. If a recording medium is found to be such a medium, the initial processing (S213 of FIG. 2) is omitted.

However, since in this example the “unique information” and “history information” are acquired before the initial processing, the library information or message can be displayed without waiting for the completion of the initial processing. These “unique information” and “history information” may also be acquired in parallel with the “initial processing”.

More specifically, in the example screen of FIG. 5, IDs such as #1 are attached to distinguish a plurality of recording media and the IDs are correlated with the “unique information” and stored (these information here are called library management information). That is, a search is made to see if “unique information” retrieved from the inserted second recording medium 110 is found among the “unique information” stored in the recording medium. If such “unique information” is found, this means that the video recording and reproducing apparatus holds the library information. If not, it means that there is no library information associated with that second recording medium (S208 of FIG. 2).

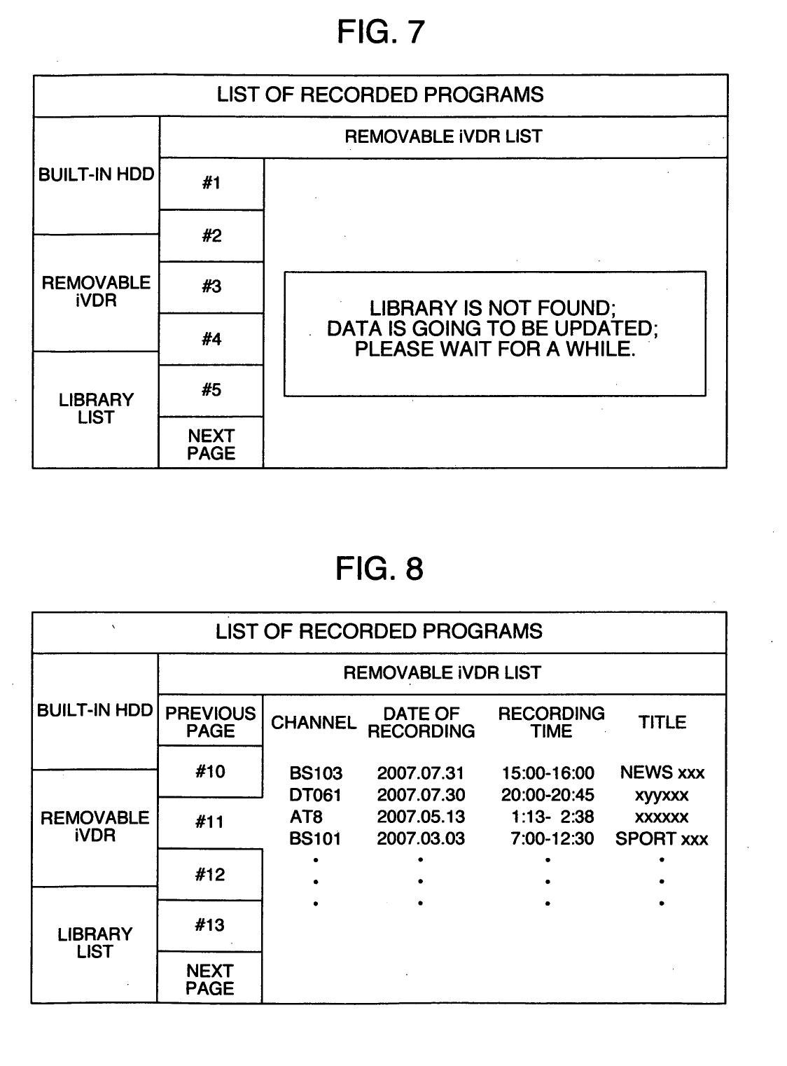

If “unique information” correlated with the library information does not exist, a message saying, for instance, “no library (information) is found; data is going to be updated; please wait for a while” as shown in FIG. 7, notifying the user that there is no library information about the second recording medium 110 currently inserted (S209 of FIG. 2). Other messages may also be used, such as “recording medium is not registered with library; data is going to be updated; please wait for a while”.

When library information is not found, new library information is retrieved from the inserted second recording medium 110 (S215 of FIG. 2) after the initial processing on the second recording medium 110 is finished (S214 of FIG. 2). With the library information retrieved from the second recording medium 110 (S216 of FIG. 2), the library information held in the video recording and reproducing apparatus is updated (S217 of FIG. 2) and the new library information is displayed (S218 of FIG. 2).

If “unique information” correlated with the library information exists, the library information associated with the second recording medium 110 is called up by using the unique information as a key and displayed as shown in FIG. 8 (S210 of FIG. 2). In the example of FIG. 8, the unique information that the video recording and reproducing apparatus has assigned to the inserted iVDR is ID=#11 and the library information about #11 is displayed.

Next, a comparison is made between the “history information” retrieved from the second recording medium 110 and the “history information” held by the video recording and reproducing apparatus to check whether the content of the inserted second recording medium 110 has been updated (S211 of FIG. 2). Consider a case, for example, in which the last recording time is used as the history information. If a last recording time held in the video recording and reproducing apparatus differs from a retrieved last recording time, it is understood that the content of the second recording medium 110 has been updated. This check can be made more quickly than when the content is compared by accessing each program after the initial processing of the second recording medium 110 is finished. The content may be, for example, audio and video information of television programs.

If the content of the inserted second recording medium 110 has not been updated, the screen remains the same as displayed at S210. If the content is found updated, new library information is retrieved from the inserted second recording medium 110 (S215 of FIG. 2) after the initial processing on the second recording medium 110 has been finished (S214 of FIG. 2). Here, when the content is found updated, a message may be displayed reading, for example, “Content of the inserted recording medium has been updated” or “Library information is going to be updated; please wait for a while.” However, in circumstances where the content of the recording medium has not changed so much, it is desired that the library information before the update be shown to the user.

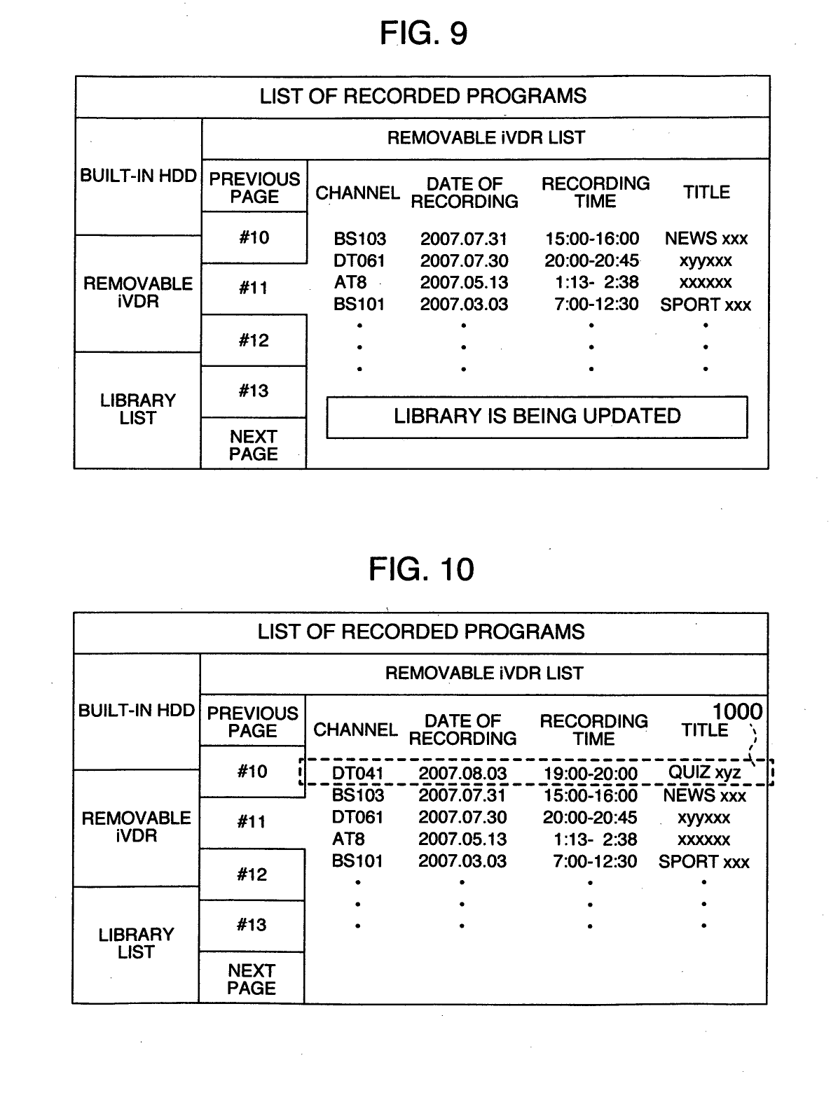

After the library information is retrieved from the second recording medium 110 (S216 of FIG. 2), the library information held in the video recording and reproducing apparatus is updated (S217 of FIG. 2) and the new library information is displayed (S218 of FIG. 2). When the library is being updated, a message reading, for example, “Library is being updated” is displayed, as shown in FIG. 9. When the update is finished, a screen such as shown in FIG. 10 is displayed. In FIG. 10, an area enclosed by a dashed line, 1000, has been added by the library update.

### Example Procedure when Power is Turned on

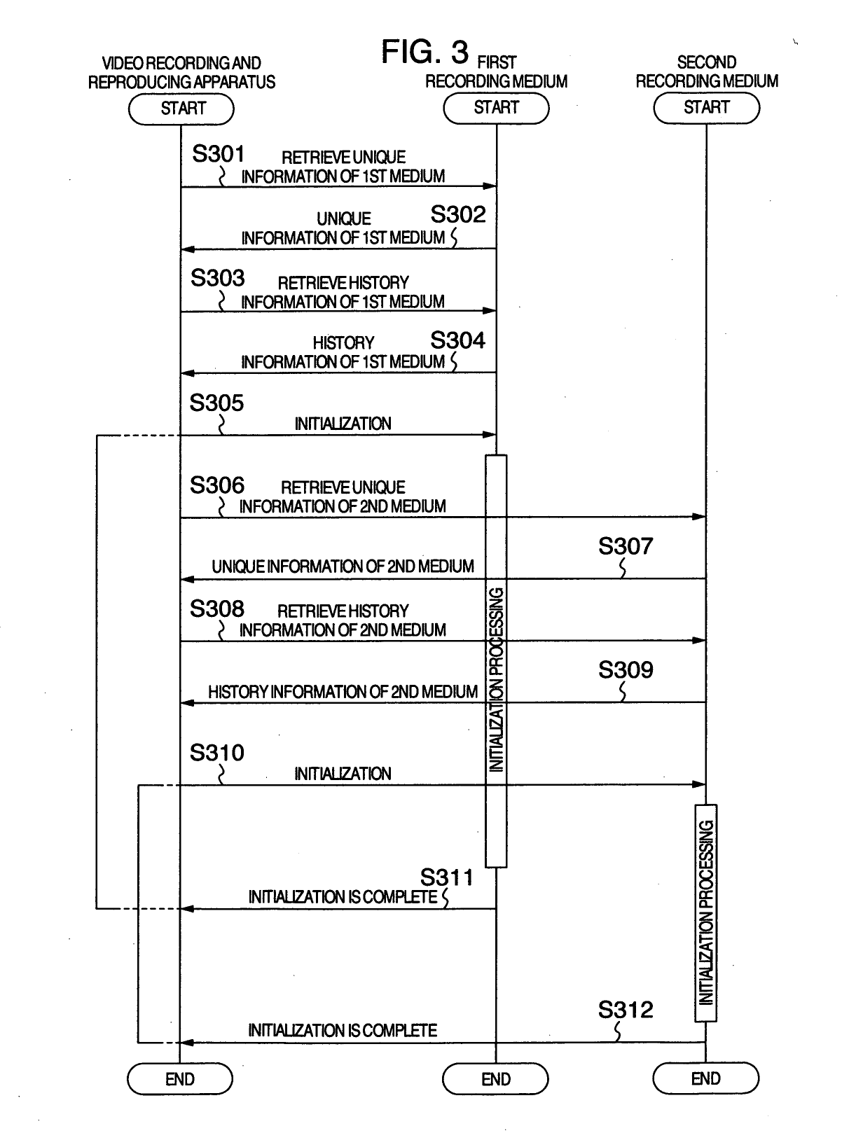

In a video recording and reproducing apparatus with a recording medium that requires initial processing which takes a predetermined time to complete, when a power is turned on, information in the recording medium cannot be accessed at least until the initial processing on the recording medium is finished. To address this problem, a procedure to allow an access to information in the recording medium even at the time of power turn-on will be explained by referring to FIG. 3.

When the power of the video recording and reproducing apparatus is turned on, unique information and history information about the first recording medium 105 are retrieved (S301 to S305 of FIG. 3). Access cannot be made to the first recording medium 105 while it is undergoing the initial processing (S305-S311 of FIG. 3). If the library information is stored in a recording medium other than the first recording medium 105 and second recording medium 110 (e.g., nonvolatile memory), the user, after retrieving the unique information and history information of the first recording medium 105, can check the library information of the first recording medium and such information as available capacity of the recording mediums.

The same also applies to the second recording medium 110. First, unique information and history information of the second recording medium 110 are retrieved (S306 to S309 of FIG. 3). The second recording medium 110 begins to be initialized (S310 of FIG. 3). While the first recording medium 105 is undergoing the initial processing (S310-S312 of FIG. 3), access cannot be made to the second recording medium 110. If the library information is stored in a recording medium other than the first recording medium 105 and the second recording medium 110, the user, after retrieving the unique information and history information of the second recording medium 110, can check the library information of the first recording medium and the available capacity of the recording mediums. If the library information of the second recording medium 110 is stored in the first recording medium 105, access to the library information must wait until the completion of the initialization of the first recording medium 105. Here the order of starting starts from one of a plurality of recording mediums storing the library information.

### Example Procedure for Checking Library Information by Using Remote Controller

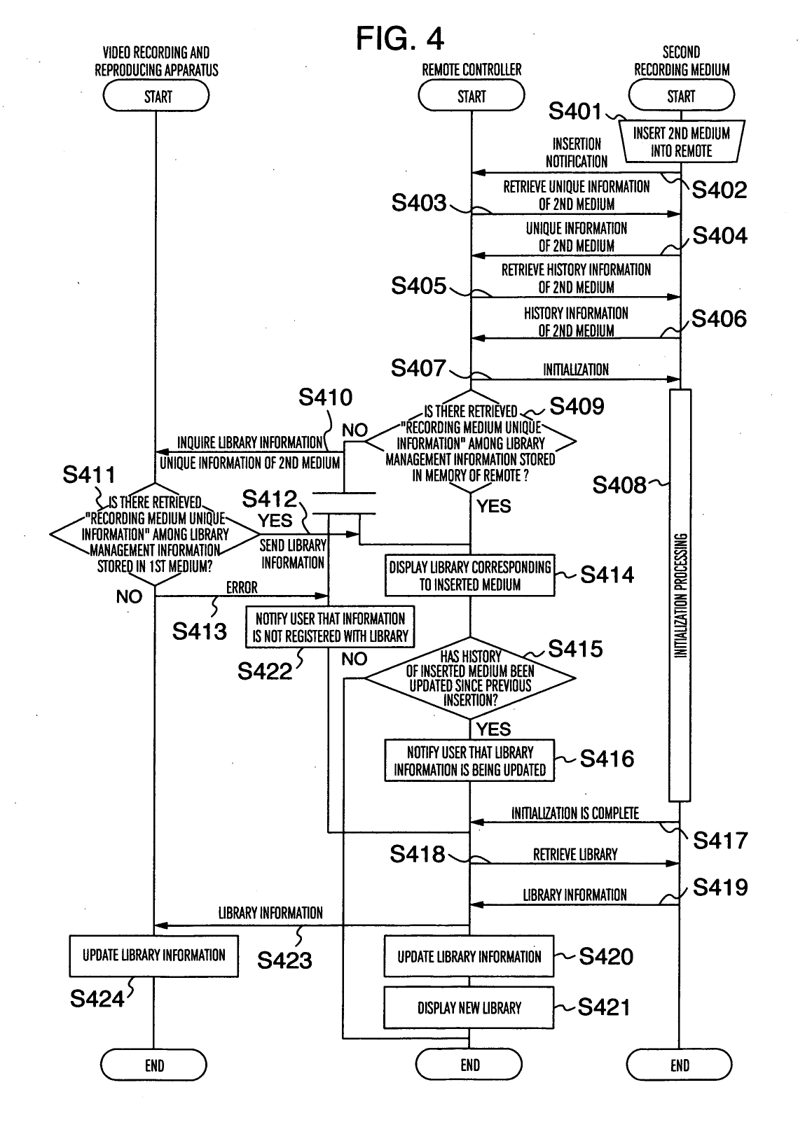

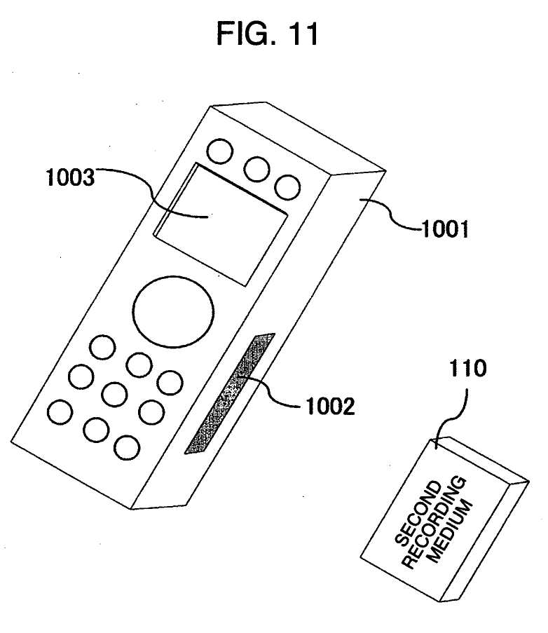

In the preceding example a removable second recording medium 110 has been described to be inserted into the slot 107 of the video recording and reproducing apparatus. An example case in which a removable medium is inserted into other than the slot 107 of the video recording and reproducing apparatus will be explained by referring to FIG. 4 and FIG. 11.

FIG. 11 shows an external view of a remote controller 1001. Denoted 1002 is a slot into which a removable recording medium is inserted; and 1003 a display showing a variety of information. In this embodiment, it is assumed that library management information is stored in a memory of the remote controller 1001 and in a first recording medium of the video recording and reproducing apparatus.

FIG. 4 shows an example procedure by which the remote controller 1001 and the video recording and reproducing apparatus cooperate to display the library information of the removable second recording medium 110.

When a second recording medium 110 is inserted into the slot 1002 of the remote controller 1001 (S401 of FIG. 4), the video recording and reproducing apparatus receives an insertion notification (S402 of FIG. 4). Although, to facilitate understanding, the second recording medium 110 in this example sends the insertion notification to the video recording and reproducing apparatus, the remote controller 1001 may detect by hardware when the second recording medium 110 is inserted.

Upon detecting the insertion of the second recording medium 110, the video recording and reproducing apparatus retrieves “unique information” and “history information” of the second recording medium 110 (S403 to S405 in FIG. 4). Here, there is no limitation on the order of retrieving the “unique information” and “history information”.

The remote controller 1001 performs initial processing on the second recording medium 110 (S407 of FIG. 4).

The remote controller 1001 searches through the library management information stored in its to see if the “unique information” retrieved from the second recording medium 110 exists in the library management information (S409 of FIG. 4). If the unique information does not exist, the remote controller inquires of the video recording and reproducing apparatus whether it holds the library information on the second recording medium 110 (S410 of FIG. 4). At this time it is preferred that the “unique information” retrieved from the second recording medium 110 be sent to the video recording and reproducing apparatus. The video recording and reproducing apparatus checks if the “unique information” retrieved from the inserted second recording medium 110 exists among the library management information stored in the first recording medium (S411 of FIG. 4). If it exists, the apparatus sends the library information associated with the second recording medium 110 to the remote controller 1001 (S412 of FIG. 4). At this time, the history information about the second recording medium 110 is also sent. If the unique information does not exist, the apparatus sends an error or message indicating that there is no such information to the remote controller (S413 of FIG. 4), and waits for the initialization of the second recording medium 110 to be completed.

If there is library information of the second recording medium 110 in the memory of the remote controller 1001 or if the remote controller 1001 acquires library information of the second recording medium 110 from the video recording and reproducing apparatus, the remote controller 1001 displays the library information of the second recording medium 110 on the display 1003 (S414 of FIG. 4).

Next, the remote controller 1001 compares the “history information” retrieved from the second recording medium 110 with the “history information” held in the remote controller 1001 or video recording and reproducing apparatus to see if the content of the inserted second recording medium 110 has been updated (S415 of FIG. 4). If the content of the inserted second recording medium 110 has not been updated, what is shown on the display remains the same. If it has been updated, the remote controller notifies the user that the library information is being updated (S416 of FIG. 4) and, after the initialization of the second recording medium 110 is completed (S417 of FIG. 4), acquires new library information from the inserted second recording medium 110 (S418 of FIG. 4). After the library information has been acquired from the second recording medium 110 (S419 of FIG. 4), the remote controller sends the library information to the video recording and reproducing apparatus (S423 of FIG. 4), updates the library information held in the remote controller 1001 (S420 of FIG. 4) and displays the new library information (S421 of FIG. 4). The video recording and reproducing apparatus, upon receiving the library information of the second recording medium 110 from the remote controller 1001, updates the library information.

It should be further understood by those skilled in the art that although the foregoing description has been made on embodiments of the invention, the invention is not limited thereto and various changes and modifications may be made without departing from the spirit of the invention and the scope of the appended claims.

1. A recording medium handling apparatus comprising:
an initialization execution unit to execute initialization processing on a recording medium;
a management information acquisition unit to acquire management information of the recording medium before the initialization processing is finished; and
a library information output unit to output library information corresponding to the management information acquired by the management information acquisition unit.

2. A recording medium handling apparatus according to claim 1, further including:
an insertion detection unit to detect an insertion of a recording medium;
wherein the management information acquisition unit, when it detects that a recording medium is inserted into a slot of the recording medium handling apparatus, acquires management information of the inserted recording medium.

3. A recording medium handling apparatus according to claim 1, wherein the management information acquisition unit, when the recording medium handling apparatus is powered on, acquires management information of the recording medium.

4. A recording medium handling apparatus according to claim 1, further including:
a control unit to, when the management information acquired by the management information acquisition unit differs from management information stored in the recording medium handling apparatus, perform control to read a recorded content of the recording medium, generate library information and update the library information output from the library information output unit with the generated library information.

5. A recording medium handling apparatus according to claim 1, wherein the initialization processing includes connection processing and certification processing.

6. A recording medium handling apparatus according to claim 1, wherein the management information includes unique information of each recording medium and history information on recording into the recording medium.

7. A recording medium handling apparatus comprising:
an initialization execution unit to execute certification processing for a recording medium; and
a control unit to output library information corresponding to the recording medium before the certification processing is completed.

8. A recording medium handling apparatus according to claim 7, wherein if the recording medium is first recorded by the recording medium handling apparatus and subsequently recorded by other recording medium handling apparatus, the library information output from the control unit is output and then updated.

9. A recording medium handling method comprising the steps of:
executing initialization processing on a recording medium and acquiring unique information of the recording medium before the initialization processing is completed; and
outputting library information corresponding to the acquired unique information.

10. A recording medium handling method according to claim 9, further including the steps of:
acquiring history information of the recording medium before the initialization processing is completed; and
when the acquired history information is found to have been recorded more recently than was history information in a recording medium handling apparatus, updating the output library information and again outputting the updated library information.
